(19) United States
(12) Patent Application Publication
(10) Pub. No.: US 2026/0001298 A1
(43) Pub. Date: Jan. 1, 2026

(54) AUTOMATED LAMINATION LINK FOR HYBRID PANEL CONVERSION OF GLASS CORE PANEL

(71) Applicant: Intel Corporation, Santa Clara, CA (US)

(72) Inventors: Son NGUYEN, Gilbert, AZ (US); David VICKERY, Gilbert, AZ (US); Manohar KONCHADY, Chandler, AZ (US); Thomas HEATON, Gilbert, AZ (US); Dilan SENEVIRATNE, Phoenix, AZ (US); Yi CAO, Chandler, AZ (US); Whitney BRYKS, Tempe, AZ (US); Joshua STACEY, Chandler, AZ (US); Shuqi LAI, Phoenix, AZ (US); Jieying KONG, Chandler, AZ (US); Jade LEWIS, Phoenix, AZ (US); Joseph PEOPLES, Gilbert, AZ (US); Bainye ANGOUA, Chandler, AZ (US); Srinivas PIETAMBARAM, Chandler, AZ (US)

(21) Appl. No.: 18/757,608

(22) Filed: Jun. 28, 2024

(51) Int. Cl. B32B 3/04; B32B 17/06; B32B 33/00; B32B 37/26; B32B 38/00; B32B 38/18; B65G 49/06

(52) U.S. Cl. CPC B32B 3/04; B32B 17/061; B32B 33/00; B32B 37/26; B32B 38/0036; B32B 38/1833; B32B 38/1858; B65G 49/067; B32B 2037/268; B32B 2255/06; B32B 2255/26; B32B 2307/202; B32B 2311/12; B32B 2315/08; B32B 2367/00

(57) ABSTRACT

The present disclosure generally relates to a glass substrate comprising a glass core, a first buffer layer in contact with the glass core, a composite build-up layer incorporated in the first buffer layer, and an electrically conductive frame, wherein the first buffer layer, the composite build-up layer, and the electrically conductive frame, are peripherally disposed around the glass core. A method and a system are also disclosed.

### BACKGROUND

Panels and substrates having a glass core tend not to be suitable for processing in factories (e.g., semiconductor fabrication plant) equipped with traditional machines. The fragility of glass renders such panels and substrates highly susceptible to breakage when processing through such equipment in existing production lines, which may present further difficulties as follow.

For example, there may be compatibility concerns with traditional machinery that are not configured or equipped to handle the rigidity and any dimensional variations associated with glass core panels and substrates. This may then lead to operational issues such as jamming or misalignment during processing.

As another example, material loss may occur. The breakage of glass panels and substrates during processing translates directly to wasted raw materials and damaged goods. This may considerably affect production yield.

As a further example, safety may be compromised. The potential for shattered glass poses a significant safety hazard to personnel working on the production line. Integrating glass core panels and substrates may necessitate the implementation of additional safety protocols that may be time consuming and perhaps require modifications to existing equipment to mitigate any safety risks.

Integration of glass core panels and substrates into existing production lines remains a challenge that may undesirably require a comprehensive engineering overhaul and modification to both the machinery and traditional processing protocols.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1A shows a schematic diagram of the modules involved in forming a glass substrate described in aspects of the present disclosure;

FIG. 1B shows a robot arm (e.g., a rotatable arm), which an alignment module of a system described in aspects of the present disclosure (as an example), may include;

FIG. 1C shows a robot arm (e.g., a rotatable arm) and a conveying unit of an alignment module of a system described in aspects of the present disclosure;

FIG. 2 is a flow diagram illustrating how the glass substrate is formed via a method described in aspects of the present disclosure;

FIG. 3 illustrates a polyethylene terephthalate (PET) film involved in the method of FIG. 2;

FIG. 4 is a flow diagram illustrating how the glass substrate is formed via a method described in aspects of the present disclosure; and

FIG. 5 shows a plan view of a non-limiting example of the glass substrate described in aspects of the present disclosure.

### DETAILED DESCRIPTION

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects may be combined with one or more other aspects to form new aspects.

The present disclosure may attempt to address any of the issues and limitations associated with processing of glass panels and substrates in factories (e.g., semiconductor fabrication plant), wherein the production lines are equipped with traditional machines not compatible with handling of glass panels and substrates.

The present disclosure may attempt to address any of the issues and limitations associated with the fragility of glass panels and substrates, which are brittle materials, hence challenging to process in equipment not modified or configured to deal with such glass panels and substrates. The term “fragility” refers to ease with which a material can be damaged (e.g., broken). The term “brittle” refers to a physical property of a material, which is a measure of the material's tendency to break without undergoing permanent shape change when subjected to stress.

The present disclosure generally relates to a glass substrate that circumvents the issues and limitations mentioned above. The terms “glass substrate” and “glass panel” are used interchangeably in the present disclosure. As mentioned above, substrates formed of glass or having a glass core tend not to be suitable for processing in existing factories and production lines (e.g., in semiconductor manufacturing) having machines not configured to handle such glass substrates. Said differently, glass substrates being brittle in nature may be extremely susceptible to breakage during processing. The glass substrate of the present disclosure addresses the issues and limitations mentioned above, as the glass substrate is a “hybrid” panel that includes a glass core embedded in an “organic frame” that renders a glass substrate capable of surviving aggressive processing (e.g., in semiconductor processing). The glass substrate of the present disclosure may be termed a “hybrid” panel, as the glass substrate includes components (other than a glass core) that may be formed of a material different from glass, i.e., the components are not formed of glass. The material of the components may be primarily composed of carbon, which may include hydrogen, oxygen, nitrogen, etc., hence described as “organic” and hence the term “organic frame” is used. Advantageously, the “hybrid” panels (i.e., glass substrate of the present disclosure formed with such components) can be processed, or even fabricated, with existing equipment.

The present disclosure also generally relates to a method. The method can be a method for fabricating the glass substrate. The glass substrate formed from the method can be further processed in traditional machineries and equipment without being limited by the fragility and brittleness of the glass core in the glass substrate. Advantageously, the method may be automated to load a glass core into an alignment module configured to align components for forming the glass substrate, to load a glass core into a lamination module configured to form a glass substrate from the glass core, and to unload the glass substrate from the lamination module. Said differently, after the various modules are configured, the various modules may operate independently without human intervention until after the glass substrate is formed and unloaded from the unloading module. The method may involve integrating an alignment module with a lamination module, wherein the lamination module may be configured downstream of (e.g., directly downstream of) the alignment module.

The present disclosure also generally relates to a system. The system is operable for making the glass substrate. The system is operable to carry out the method as mentioned above. The glass substrate formed from the system can be further processed in traditional machineries and equipment without being limited by the fragility and brittleness of the glass core in the glass substrate. Advantageously, the system may be automated to load a glass core into an alignment module configured to align components for forming the glass substrate, to load a glass core into a lamination module configured to form a glass substrate from the glass core, and to unload the glass substrate from the lamination module. Said differently, after the various modules are configured, the various modules may operate independently without human intervention until after the glass substrate is formed and unloaded from the unloading module. The system may involve an alignment module that may be integrated to a lamination module, wherein the lamination module may be configured downstream of (e.g., directly downstream of) the alignment module. The term “integrated” in the context of the present disclosure means that two or more modules in the system may exist physically separated but still operably linked, or the two or more modules in the system may be combined to form one machine that includes the two or more modules.

The method and system of the present disclosure may be advantageous for converting a glass core into a hybrid panel having the glass core, as it involves a fully automated lamination tool and are operable for high volume manufacturing of the hybrid panel. The method and system may aid to circumvent the issues and limitations mentioned above, as traditional production lines in factories, and traditional machineries and equipment, tend to be not suitable for handling fragile and brittle glass materials.

To more readily understand and put into practical effect the present disclosure, particular aspects will now be described by way of examples and not limitations, and with reference to the drawings. For the sake of brevity, duplicate descriptions of features and properties may be omitted.

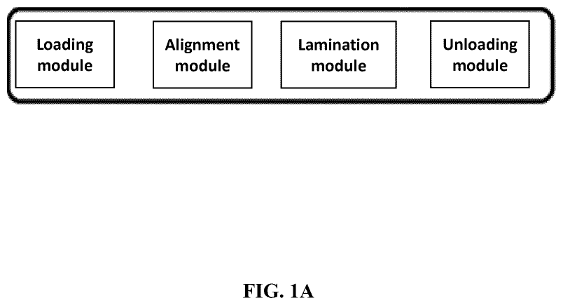

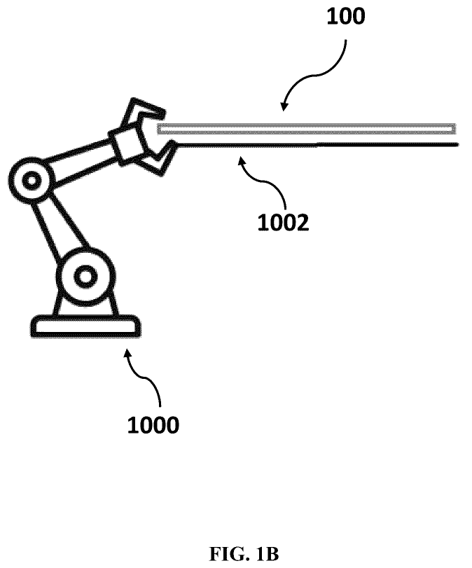

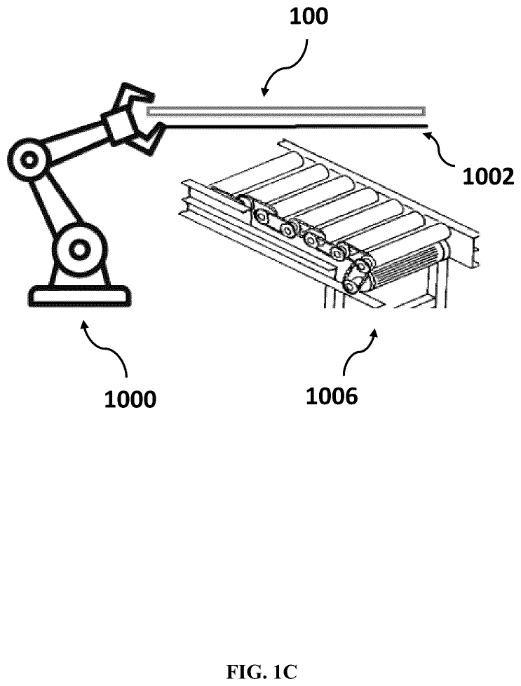

FIG. 1A shows a schematic diagram of the system of the present disclosure. The system may include a loading module and an alignment module. The loading module may include an arm operable to convey a substrate carrier to the alignment module. The alignment module may include an arm operable to align an electrically conductive frame and a glass core with each other on the substrate carrier. The arm of the alignment module may be operable to rotate (e.g., flip) any components. The system may include a lamination module configured downstream of the alignment module. The lamination module is operable to form a glass substrate from the glass core. The alignment module may be integrated with the lamination module. The system may include an unloading module. The unloading module may include an arm operable to convey the glass substrate out from the lamination module. The operation of the various modules may be automated so as to allow the system to operate independently without human intervention. For example, the transfer of a substrate carrier with a glass core may occur without human operating the loading and unloading modules. Also, arrangement of components on the substrate carrier by the alignment module, and any lamination occurring in the lamination module, may be carried out without a human operating these modules and processes. As the operation of the various modules may be automated and the various modules may be operably linked, the present system may be referred to as an “automated linked system”. Details of the system and various modules are described in the example section below.

FIG. 1B shows a robot arm 1000. For brevity, the robot arm 1000 may be referred in the present disclosure as “arm”. The loading module, the alignment module, the lamination module, and/or the unloading module, optionally, may be configured with such a robot arm 1000. The robot arm 1000 may be rotatable. The robot arm 1000 has clamps to hold one or more components (e.g., glass core 100 or even glass substrate) for flipping. The robot arm 1000 may be configured, optionally, with a support 1002, the support 1002 may be configured for the one or more components (e.g., a glass core 100 or even glass substrate) to be placed thereon, which may help facilitate transport of the one or more components from one position to another.

FIG. 1C shows a robot arm 1000 and a conveying unit 1006 of the alignment module. The robot arm 1000 may be rotatable. The robot arm 1000 may be configured to be able to pick up one or more components (e.g., a glass core 100 or even a glass substrate) and placed it on a conveying unit 1006 of the alignment module. The robot arm 1000 may also be configured to place the one or more components on a conveying unit (not shown) of the lamination module, said differently, the lamination module, optionally, may include a conveying unit 1006. The robot arm 1000 may be configured, optionally, with a support 1002, the support 1002 may be configured for the one or more components (e.g., a glass core 100 or even glass substrate) to be placed thereon, which may help facilitate transport of the one or more components from one position to another. The conveying unit 1006 may include rollers, operably coupled, to convey the one or more components (e.g., a glass core 100 or even a glass substrate) from one position to another.

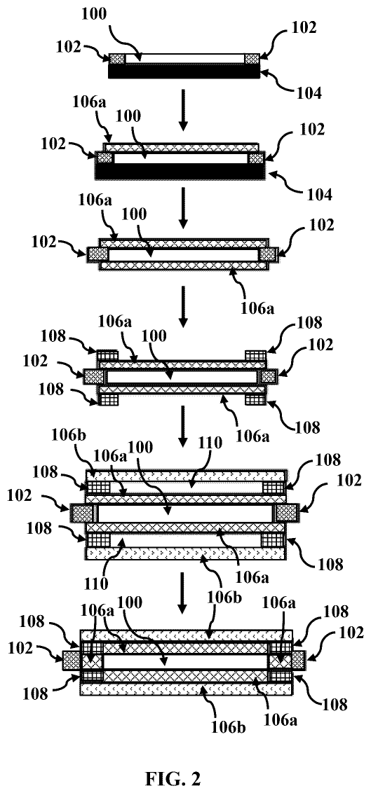

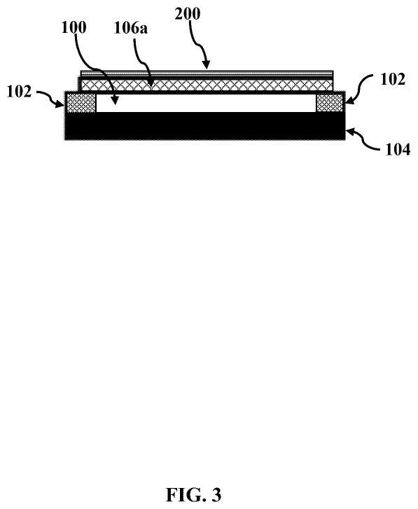

FIG. 2 is a flow diagram depicting a method of the present disclosure. Particularly, FIG. 2 shows how a glass substrate of the present disclosure may be formed. Initially, a substrate carrier 104 may be provided. The substrate carrier 104 may be provided with a glass core 100 and an electrically conductive frame 102 aligned thereon. For example, the electrically conductive frame 102 and the glass core 100 may be disposed on the substrate carrier 104, wherein the electrically conductive frame 102 may be aligned with vertical edges of the glass core 100, and the glass core 100 may be disposed within an opening of the electrically conductive frame 102. Alignment of the glass core 100 and the electrically conductive frame 102 with respect to each other and to the substrate carrier 104 may be carried out with the alignment module. Next, the substrate carrier 104 with the glass core 100 and electrically conductive frame 102 may be transferred to the lamination module. A first buffer layer 106a may be disposed on a first surface of the glass core 100. The first buffer layer 106a may also be disposed, or partially disposed, on the electrically conductive frame 102. There may be a layer of polyethylene terephthalate (PET) film 200 (see FIG. 3) on a surface of the first buffer layer 106a that faces away from the glass core 100. The first buffer layer 106a (with the PET film) may be laminated to the glass core 100 (at the first surface). After laminating the first buffer layer 106a to the glass core 100 at the first surface, the PET film may be removed. Next, the substrate carrier 104 may be removed and the glass core 100 may be rotated (flipped over) to have the first buffer layer 106a disposed on a second surface of the glass core 100. The first buffer layer 106a at the second surface may also be disposed, or partially disposed, on the electrically conductive frame 102. There may be a layer of PET film (not shown) on a surface of the first buffer layer 106a that faces away from the glass core 100. The first buffer layer 106a (with the PET film) may be laminated to the glass core 100 (at the second surface). After laminating the first buffer layer 106a to the glass core 100 at the second surface, the PET film may be removed. Removal of the PET film may be carried out in the lamination module by peeling off the PET film. Next, a composite build-up layer 108 may be disposed on the first buffer layer 106a parallel to a length of the glass core 100 and along four corners (or along perimeter) of the glass core 100. For example, the composite build-up layer 108 may be applied on the first buffer layer 106a at the first surface of the glass core 100, for example as one or more strips, along the length of the glass core 100 and near the vertical edges of the glass core 100. The glass core 100 may then be rotated to dispose the composite build-up layer 108 on the first buffer layer 106a at the second surface of the glass core 100, for example as one or more strips, along the length of the glass core 100. Next, a second buffer layer 106b may be disposed on the composite build-up layer 108 (understandably on the first buffer layer 106a) at the first surface of the glass core 100. There may be a space 110 between the first buffer layer 106a and the second buffer layer 106b, wherein the space 110 may be absent after lamination. There may be a polyethylene terephthalate (PET) film (not shown) on a surface of the second buffer layer 106b that faces away from the glass core 100. The glass core 100 may be rotated to dispose the second buffer layer 106b on the composite build-up layer 108 (understandably on the first buffer layer 106a) at the second surface of the glass core 100. There may be a space 110 between the first buffer layer 106a and the second buffer layer 106b, wherein the space 110 may be absent after lamination. There may be a polyethylene terephthalate (PET) film (not shown) on a surface of the second buffer layer 106b that faces away from the glass core 100. Next, the second buffer layer 106b may undergo lamination to be laminated to the glass core 100 (lamination to both first and second surfaces of the glass core 100). With the lamination of the second buffer layer 106b to the glass core 100 (and understandably to the first buffer layer 106a), the composite build-up layer 108 may be incorporated into (e.g., embedded entirely in) the first buffer layer 106a. The PET films at both surfaces may be removed from the second buffer layer 106b after the lamination. In various aspects and examples, the second buffer layer 106b disposed at the first surface of the glass core 100 may be first laminated, then the glass core 100 may be rotated for the second buffer layer 106b to be disposed and laminated at the second surface of the glass core 100, as an alternative to first disposing the second buffer layer 106b on both surfaces then laminate. In the method (not shown), the glass core 100 may be rotated in the lamination module (or in the alignment module) to have the first surface face upwards after a disposition or a lamination with the second surface is completed. For example, after disposing and laminating the first buffer layer 106a at the second surface of the glass core 100, the glass core 100 may be rotated to its original position (e.g., the first surface of the glass core 100 face upwards). Observably, the first buffer layer 106a, the composite build-up layer 108, and the electrically conductive frame 102, may be peripherally disposed around the glass core 100. The method shown in FIG. 2 is advantageous in that the glass substrate constructed may have reduced height difference (vertical distance) between the composite build-up layer 108 and the glass core 100 (as the composite build-up layer 108 may be embedded entirely in the first buffer layer 106a), suitable for applications that require such glass substrate. In the method shown in FIG. 2, the first buffer layer 106a may be used to adhere the electrically conductive frame 102 and the glass core 100. The composite build-up layer 108 may be applied along perimeter of the glass core 100 to fill any gap between the glass core 100 and the electrically conductive frame 102. Then, the second buffer layer 106b may be applied to help meet any thickness requirement (e.g., to meet a total thickness requirement, if any, of the first buffer layer 106a and/or second buffer layer 106b).

FIG. 3 shows the PET film 200 disposed on the first buffer layer 106a prior to the PET film's 200 removal.

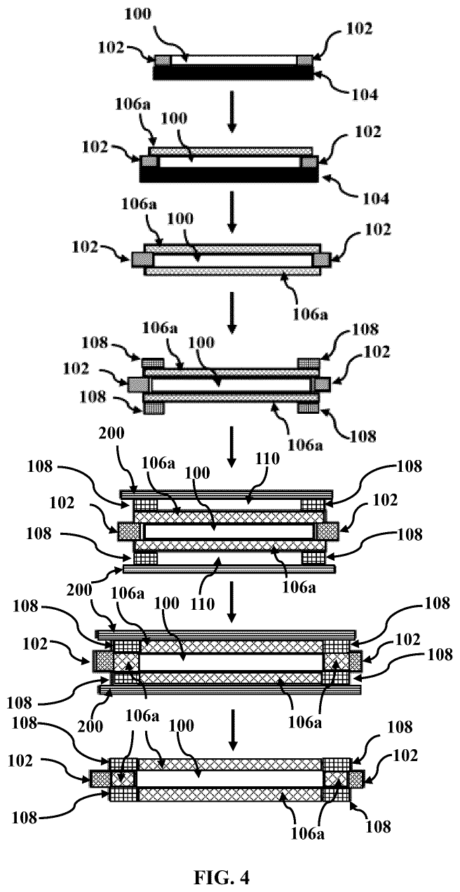

FIG. 4 is a flow diagram depicting a method of the present disclosure. Particularly, FIG. 4 shows how a glass substrate of the present disclosure may be formed. The method of FIG. 4 is premised on the method of FIG. 2, but may differ in that instead of a second buffer layer, PET films 200 are used. Initially, a substrate carrier 104 may be provided. The substrate carrier 104 may be provided with a glass core 100 and electrically conductive frame 102 aligned thereon. For example, the electrically conductive frame 102 and the glass core 100 may be disposed on the substrate carrier 104, wherein the electrically conductive frame 102 may be aligned with vertical edges of the glass core 100, and the glass core 100 may be disposed within an opening of the electrically conductive frame 102. Alignment of the glass core 100 and the electrically conductive frame 102 with respect to each other and to the substrate carrier 104 may be carried out with the alignment module. Next, the substrate carrier 104 with the glass core 100 and electrically conductive frame 102 may be transferred to the lamination module. A first buffer layer 106a may be disposed on a first surface of the glass core 100. The first buffer layer 106a may also be disposed, or partially disposed, on the electrically conductive frame 102. There may be a layer of polyethylene terephthalate (PET) film 200 (see FIG. 3) on a surface of the first buffer layer 106a that faces away from the glass core 100. The first buffer layer 106a (with the PET film) may be laminated to the glass core 100 (at the first surface). After laminating the first buffer layer 106a to the glass core 100 at the first surface, the PET film may be removed. Next, the substrate carrier 104 may be removed and the glass core 100 may be rotated (flipped over) to have the first buffer layer 106a disposed on a second surface of the glass core 100. The first buffer layer 106a at the second surface may also be disposed, or partially disposed, on the electrically conductive frame 102. There may be a layer of PET film (not shown) on a surface of the first buffer layer 106a that faces away from the glass core 100. The first buffer layer 106a (with the PET film) may be laminated to the glass core 100 (at the second surface). After laminating the first buffer layer 106a to the glass core 100 at the second surface, the PET film may be removed. Removal of the PET film may be carried out in the lamination module by peeling off the PET film. Next, a composite build-up layer 108 may be disposed on the first buffer layer 106a parallel to a length of the glass core 100 and along four corners (or along perimeter) of the glass core 100. For example, the composite build-up layer 108 may be applied on the first buffer layer 106a at the first surface of the glass core 100, for example as one or more strips, along the length of the glass core 100 and near the vertical edges of the glass core 100. The glass core 100 may then be rotated to dispose the composite build-up layer 108 on the first buffer layer 106a at the second surface of the glass core 100, for example as one or more strips, along the length of the glass core 100. Next, a PET film 200 may be disposed on the composite build-up layer 108 (understandably on the first buffer layer 106a) at the first surface of the glass core 100. There may be a space 110 between the first buffer layer 106a and the PET film 200, wherein the space 110 may be absent after lamination. The glass core 100 may be rotated to dispose another PET film 200 on the composite build-up layer 108 (understandably on the first buffer layer 106a) at the second surface of the glass core 100. There may be a space 110 between the first buffer layer 106a and the PET film 200, wherein the space 110 may be absent after lamination. Next, the PET film 200 may undergo lamination to be laminated to the glass core 100 (lamination to both first and second surfaces of the glass core 100). With the lamination of the PET film 200 to the glass core 100 (and understandably to the first buffer layer 106a), the composite build-up layer 108 may be incorporated into (e.g., embedded entirely in) the first buffer layer 106a. The PET films 200 at both surfaces may be removed from the first buffer layer 106a after the lamination. In various aspects and examples, the PET film 200 disposed at the first surface of the glass core 100 may be first laminated, then the glass core 100 may be rotated for another PET film 200 to be disposed and laminated at the second surface of the glass core 100, as an alternative to first disposing the PET film 200 on both surfaces then laminate. In the method (not shown), the glass core 100 may be rotated in the lamination module (or in the alignment module) to have the first surface face upwards after a disposition or a lamination with the second surface is completed. For example, after disposing and laminating the first buffer layer 106a at the second surface of the glass core 100, the glass core may be rotated to its original position (e.g., the first surface of the glass core 100 face upwards). Observably, the first buffer layer 106a, the composite build-up layer 108, and the electrically conductive frame 102, may be peripherally disposed around the glass core 100. The method shown in FIG. 4 is advantageous in that the glass substrate constructed may have a reduced height difference (vertical distance) between the composite build-up layer 108 and the glass core 100 (as the composite build-up layer 108 may be embedded entirely in the first buffer layer 106a), suitable for applications that require such glass substrate. In the method shown in FIG. 4, the first buffer layer 106a may be used to adhere the electrically conductive frame 102 and the glass core 100. The composite build-up layer 108 may be applied along perimeter of the glass core 100 to fill any gap between the glass core 100 and the electrically conductive frame 102.

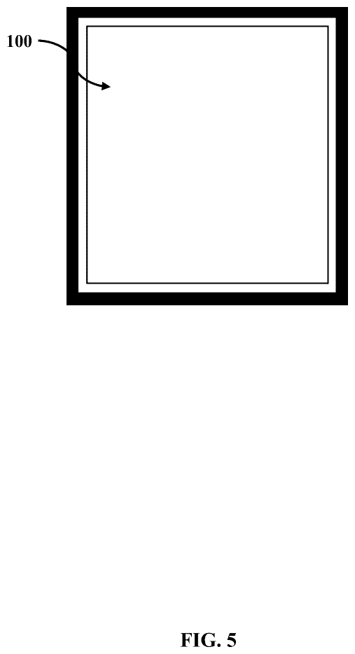

FIG. 5 shows one non-limiting example of a glass substrate (i.e., “hybrid panel”) of the present disclosure. The glass substrate is formed by the method and system of the present disclosure. The glass substrate (with the glass core 100), advantageously, passed a survivability test, wherein the glass substrate was processed through traditional equipment in an existing factory, and demonstrated minimal warpage of 0.5 mm after the survivability test.

### EXAMPLES

Example 1 may include a glass substrate. In various aspects and examples, the glass substrate may include a glass core, a first buffer layer in contact with the glass core, a composite build-up layer incorporated in the first buffer layer, and an electrically conductive frame. In various aspects and examples, the first buffer layer, the composite build-up layer, and the electrically conductive frame, may be peripherally disposed around (e.g., wrapped around) the glass core. The glass substrate may be referred to as a glass panel or hybrid panel, as it includes other components apart from the glass core.

Example 2 may include the glass substrate of example 1 and/or any other example disclosed herein, wherein the glass core includes a first surface, a second surface, vertical edges between the first surface and the second surface. In various aspects and examples, the first surface, the second surface, and the vertical edges, may define a rectangular prism. Said differently, the glass core may be a rectangular glass prism, i.e., the glass core may be a solid layer of glass rectangular in shape in plan view. In various aspects and examples, the glass core may be a layer of glass having a thickness in a range of 50 μm to 1.4 mm, a first length in a range of 10 mm to 250 mm, and a second length in a range of 10 mm to 250 mm, the first length perpendicular to the second length. In various aspects and examples, where the glass core has a rectangular prism volume, the rectangular prism volume may have a first side and a second side perpendicular to the first side, the first side having a length in a range of 10 mm to 250 mm and the second side having a length in a range of 10 mm to 250 mm. In various aspects and examples, the glass core may be a layer of glass that includes a rectangular prism volume and a via extending from a first side of the rectangular prism volume to a second side of the rectangular prism volume, the via including a metal. In various aspects and examples, the glass core may include a first surface, a second surface, and a vertical edge between the first surface and the second surface, wherein the first surface, the second surface, and the vertical edge, may define a cylindrical volume, that is, the glass core may have a cylindrical shape. In various aspects and examples, the glass core may be a layer of glass that includes silicon, oxygen, and aluminum. In various aspects and examples, the glass core may be a layer of glass that includes at least 23 percent silicon and at least 26 percent oxygen by weight, and may further include at least 5 percent aluminum by weight. In various aspects and examples, the glass core may be a layer of glass, wherein the layer of glass does not include an organic adhesive or an organic material. The term “organic” is already defined above. In various aspects and examples, the glass core may include a layer of glass, wherein the glass includes aluminosilicate, borosilicate, alumino-borosilicate, silica, and/or fused silica. In various aspects and examples, the glass core may be a layer of glass that include one or more additives, such as Al₂O₃, B₂O₃, MgO, CaO, SrO, BaO, SnO₂, Na₂O, K₂O, SrO, P₂O₃, ZrO₂, Li₂O, Ti, and/or Zn. In various aspects and examples, the glass core may be a layer of glass that includes silicon and oxygen, and any one or more of aluminum, boron, magnesium, calcium, barium, tin, sodium, potassium, strontium, phosphorus, zirconium, lithium, titanium, and/or zinc. In various aspects and examples, the glass core may be an amorphous solid glass.

Example 3 may include the glass substrate of example 1 and/or any other example disclosed herein, wherein the composite build-up layer may be disposed parallel to a length of the glass core. In various aspects and examples, the composite build-up layer may be disposed along one or more corners (e.g., two or four corners or along perimeter) of the glass core. In various aspects and examples, the composite build-up layer may be a layer of strip lined along the one or more corners of the glass core (e.g., see FIG. 2 and FIG. 4 composite build-up layer 108). In various aspects and examples, the composite build-up layer may be disposed parallel to a length of the glass core and along four corners of the glass core or may be disposed parallel to a length of the glass core and along a perimeter of the glass core.

Example 4 may include the glass substrate of example 2 and/or any other example disclosed herein, wherein the electrically conductive frame may be aligned with the vertical edges of the glass core and may be disposed on the first buffer layer.

Example 5 may include the glass substrate of example 2 and/or any other example disclosed herein, wherein the glass substrate may further include a second buffer layer disposed on the first buffer layer, wherein the first buffer layer may be disposed on the first surface and the second surface. In other words, the second buffer layer may be disposed on the first surface and on the second surface.

Example 6 may include the glass substrate of example 5 and/or any other example disclosed herein, wherein the first buffer layer and the second buffer layer may include an organic resin. The organic resin may be a polymer resin, for example, the organic resin may include an epoxy-based resin or a cyclized olefin polymer. In various aspects and examples, the first buffer layer and the second buffer layer may include an insulating material, a dielectric material, a heat-resistant material, a flexible material, and/or any other suitable material. In various aspects and examples, the first buffer layer and the second buffer layer may include an organic material, such as Ajinimoto build-up film (ABF), or any organic material like ABF which can be used as the first buffer layer and/or second buffer layer. Said differently, the organic resin may include ABF. The first buffer layer and the second buffer layer may be the same or different. In various aspects and examples, the first buffer layer and the second buffer layer may include a width that is at least 495 mm. The width may be configured to accommodate any requirements of the first and second buffer layers. For example, the width may be dimensioned to make room for handling edges of the glass panel (e.g., human handling or clamping). As one non-limiting example, the width of the first buffer layer and second buffer layer may be 495 mm, and the width of the glass panel may be 510 mm, such that a space (i.e., a “keep out zone” of 15 mm along the periphery of the glass panel) may be catered to allow clamping or human handling without damaging an active area of the glass panel, such as an area of the glass core.

Example 7 may include the glass substrate of example 1 and/or any other example disclosed herein, wherein the composite build-up layer may include an insulating material, a dielectric material, a heat-resistant material, a flexible material, and/or any other suitable material. In various aspects and examples, the composite build-up layer may include an organic material, such as Ajinimoto build-up film (ABF). In various aspects and examples, the composite build-up layer may include ABF or ABF and copper. In various aspects and examples, the composite build-up layer may be resin coated copper. The resin of the resin coated copper may be an organic resin. The organic resin may be a polymer resin, for example, the organic resin may include an epoxy-based resin or a cyclized olefin polymer. The resin may include ABF, any resin like ABF, any adhesive like ABF, or an organic material like ABF, which can be used to form the composite build-up layer. The resin coated copper may be made of two materials, such as a copper sheet and a resin organic sheet (or an adhesive sheet). The two sheets may be pressed under high temperature and pressure to form the resin coated copper.

Example 8 may include the glass substrate of example 1 and/or any other example disclosed herein, wherein the electrically conductive frame may include a metal or metal alloy (e.g., copper or copper alloy or any other electrically conductive metal), ceramic, rigid polymer, etc., or any other rigid or substantially rigid material. In various aspects and examples, the electrically conductive frame may include an organic material. In various aspects and examples, the electrically conductive frame may be a composite material. The composite material may include an electrically conductive metal and an organic material. The composite material may additionally include a reinforcing material. The electrically conductive frame may include the organic material as a sheet of insulating material (optionally with reinforcing material) with a sheet of the electrically conductive metal bonded to one or both sides of the organic material. The organic material may be a polymer, such as a polyimide or a polymer resin (e.g., epoxy resin, phenolic resin, polyester resin). The reinforcing material may be any material that reinforces mechanical strength of the electrically conductive frame, for example, glass fiber. In various aspects and examples, the electrically conductive frame may include a copper clad laminate. The electrically conductive frame helps protect edges of glass core from being damaged during any handling or contact (e.g., when placed on a conveying unit or when grasped with clamps of a rotatable arm of the alignment module or lamination module). Also, the surface of the electrically conductive frame may be electrically conductive for any subsequent plating thereon, if needed.

Example 9 may include a method of the present disclosure. In various aspects and examples, the method may include providing a substrate carrier, disposing an electrically conductive frame and a glass core to be in alignment with each other on the substrate carrier, disposing a first buffer layer on the glass core, disposing a composite build-up layer to be incorporated in the first buffer layer, and laminating the first buffer layer and the composite build-up layer to the glass core to have the first buffer layer, the composite build-up layer, and the electrically conductive frame, peripherally disposed around the glass core.

Example 10 may include the method of example 9 and/or any other example disclosed herein, wherein disposing the electrically conductive frame and the glass core on the substrate carrier may include aligning the electrically conductive frame with vertical edges of the glass core, and disposing the glass core within an opening of the electrically conductive frame.

Example 11 may include the method of example 9 and/or any other example disclosed herein, wherein disposing a first buffer layer on the glass core may include disposing the first buffer layer on a first surface of the glass core, removing the substrate carrier from the glass core and the electrically conductive frame, and disposing the first buffer layer on a second surface of the glass core.

Example 12 may include the method of example 11 and/or any other example disclosed herein, wherein the method may further laminating the first buffer layer to the glass core after disposing the first buffer layer on the first surface, removing a polyethylene terephthalate film from the first buffer layer at the first surface after laminating the first buffer layer to the glass core at the first surface, laminating the first buffer layer to the glass core after disposing the first buffer layer on the second surface, and removing a polyethylene terephthalate film from the first buffer layer at the second surface after laminating the first buffer layer to the glass core at the second surface.

Example 13 may include the method of example 12 and/or any other example disclosed herein, wherein disposing the composite build-up layer may include disposing the composite build-up layer parallel to a length of the glass core and along (i) four corners of the glass core or (ii) a perimeter of the glass core, after removing the polyethylene terephthalate film from the first surface and the second surface.

Example 14 may include the method of example 13 and/or any other example disclosed herein, wherein the method may further include (i) disposing a second buffer layer on the first buffer layer and on the composite build-up layer, and laminating the second buffer layer to the first buffer layer and the composite build-up layer to render the composite build-up layer incorporated in the first buffer layer, or (ii) disposing a polyethylene terephthalate film on the first buffer layer and on the composite build-up layer, and laminating the polyethylene terephthalate film to the first buffer layer and the composite build-up layer to render the composite build-up layer incorporated in the first buffer layer.

Example 15 may include the method of example 14 and/or any other example disclosed herein, wherein the method may further include removing a polyethylene terephthalate film from the second buffer layer in (i) after laminating the second buffer layer to the first buffer layer and the composite build-up layer, or removing the polyethylene terephthalate film in (ii) after laminating the polyethylene terephthalate film to the first buffer layer and the composite build-up layer.

Example 16 may include the method of example 14 and/or any other example disclosed herein, wherein second buffer layer in (i) may be disposed on the first surface and the second surface, or wherein the polyethylene terephthalate film in (ii) may be disposed on the first surface and the second surface.

Example 17 may include a system of the present disclosure. In various aspects and examples, the system may include a loading module, an alignment module, wherein the loading module may include an arm operable to convey a substrate carrier to the alignment module, and wherein the alignment module may include an arm operable to align an electrically conductive frame and a glass core with each other on the substrate carrier, a lamination module configured downstream of the alignment module operable to form a glass substrate from the glass core, and an unloading module comprising an arm operable to convey the glass substrate out from the lamination module. The term “module” in the present disclosure may refer to any machine or device operable or configured to perform an intended process as described. For example, the term “lamination module” may refer to a machine or device of the system that is operable to carry out a lamination process. The term “module” may refer to a machine or device in the system, wherein the machine or device, optionally, may have a housing to house one or more parts of the machine or device therein. For example, the lamination module may include a heater, a vacuum rubber press and/or a hydraulic vacuum press, and a conveying unit. The lamination module, optionally, may include (or may be absent of) a housing that houses the heater, the vacuum rubber press and/or the hydraulic vacuum press, and/or the conveying unit. As another example, the alignment module, optionally, may include (or may be absent of) a housing. If present, the housing of the alignment module may house a robot arm and/or a conveying unit, an example of the robot arm and the conveying unit are as described for FIG. 1C. The robot arm may be rotatable. The conveying unit may include rollers operably coupled to convey one or more components of a glass substrate (e.g., a glass core) from one position to another. The loading and unloading modules, optionally, may include (or may be absent of) a housing. If present, the housing may house an arm therein operable to load and unload, respectively, one or more components of the glass substrate (e.g., a substrate carrier). In various aspects and examples, if a housing is present, the housing may include one or more openings to convey one or more components of the glass substrate in and/or out of the housing. Each of the one or more openings may include a door operable to allow the conveying of the one or more components of the glass substrate in and/or out of the housing. In various aspects and examples, the arm of the loading module and/or the arm of the unloading module may take on the configuration of the robot arm as described for FIG. 1C.

Example 18 may include the system of example 17 and/or any other example disclosed herein, wherein the arm of the loading module may be operable to have the substrate carrier placed in the alignment module to have the electrically conductive frame aligned with vertical edges of the glass core, and wherein the glass core may be disposed within an opening of the electrically conductive frame.

Example 19 may include the system of example 17 and/or any other example disclosed herein, wherein the lamination module may include a heater, a vacuum rubber press and/or a hydraulic vacuum press, and a conveying unit including rollers to convey the glass core through the vacuum rubber press and/or the hydraulic vacuum press. In various aspects and examples, the lamination module, optionally, may include a rotatable arm, wherein the rotatable arm may be operable to flip the glass substrate to have a first surface of the glass core face upward or a second surface of the glass core face upward. In various aspects and examples, the lamination module may include a lamination chamber (i.e., a lamination stage). In various aspects and examples, the conveying unit may convey one or more components of the glass substrate to the lamination stage for lamination to be carried. For example, the glass core with the first buffer layer at the glass core's first surface may be conveyed to the lamination stage where lamination of the first buffer layer to the first surface of the glass core is carried out. Then, the glass core laminated with the first buffer layer may be conveyed to the alignment module to be flipped for the first buffer layer to be applied to the second surface of the glass core, which may then be conveyed to the lamination stage where lamination of the first buffer layer to the second surface of the glass core is carried out. In various aspects and examples, the conveying unit of the lamination module may be a conveying unit as described for FIG. 1C, that is to say, having rollers, operably coupled, to convey one or more components (e.g., a glass core 100 or even a glass substrate) from one position to another.

Example 20 may include the system of example 19 and/or any other example disclosed herein, wherein the vacuum rubber press may include rubber pads operable to apply pressure and heat so as to form the glass substrate, and/or wherein the hydraulic vacuum press may include a hydraulic press operable to apply pressure under vacuum so as to form the glass substrate. In various aspects and examples, the vacuum rubber press may include rubber pads adjustable to apply pressure, and heat (from the heater), to laminate (i) a first buffer layer to the glass core and a composite build-up layer, and/or (ii) a second buffer layer to the first buffer layer and the composite build-up layer, and/or (iii) a polyethylene terephthalate film to the first buffer layer and the composite build-up layer. In various aspects and examples, the hydraulic vacuum press may include a hydraulic press to apply pressure under vacuum to laminate (i) a first buffer layer to the glass core and a composite build-up layer, and/or (ii) a second buffer layer to the first buffer layer and the composite build-up layer, and/or (iii) a polyethylene terephthalate film to the first buffer layer and the composite build-up layer.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

While the present disclosure has been particularly shown and described with reference to specific aspects, it should be understood by persons skilled in the art that various changes in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

What is claimed is:

1. A glass substrate comprising:
a glass core;
a first buffer layer in contact with the glass core;
a composite build-up layer incorporated in the first buffer layer; and
an electrically conductive frame,
wherein the first buffer layer, the composite build-up layer, and the electrically conductive frame, are peripherally disposed around the glass core.

2. The glass substrate of claim 1, wherein the glass core comprises:
a first surface;
a second surface;
vertical edges between the first surface and the second surface,
wherein the first surface, the second surface, and the vertical edges, define a rectangular prism.

3. The glass substrate of claim 1, wherein the composite build-up layer is disposed parallel to a length of the glass core and along four corners of the glass core or is disposed parallel to a length of the glass core and along a perimeter of the glass core.

4. The glass substrate of claim 2, wherein the electrically conductive frame is aligned with the vertical edges of the glass core and is disposed on the first buffer layer.

5. The glass substrate of claim 2, further comprising a second buffer layer disposed on the first buffer layer, wherein the first buffer layer is disposed on the first surface and the second surface.

6. The glass substrate of claim 5, wherein the first buffer layer and the second buffer layer comprise an organic resin.

7. The glass substrate of claim 1, wherein the composite build-up layer comprises a resin coated copper.

8. The glass substrate of claim 1, wherein the electrically conductive frame comprises a copper clad laminate.

9. A method comprising:
providing a substrate carrier;
disposing an electrically conductive frame and a glass core to be in alignment with each other on the substrate carrier;
disposing a first buffer layer on the glass core;
disposing a composite build-up layer to be incorporated in the first buffer layer; and
laminating the first buffer layer and the composite build-up layer to the glass core to have the first buffer layer, the composite build-up layer, and the electrically conductive frame, peripherally disposed around the glass core.

10. The method of claim 9, wherein disposing the electrically conductive frame and the glass core on the substrate carrier comprises:
aligning the electrically conductive frame with vertical edges of the glass core; and
disposing the glass core within an opening of the electrically conductive frame.

11. The method of claim 9, wherein disposing a first buffer layer on the glass core comprises:
disposing the first buffer layer on a first surface of the glass core;
removing the substrate carrier from the glass core and the electrically conductive frame; and
disposing the first buffer layer on a second surface of the glass core.

12. The method of claim 11, further comprising:
laminating the first buffer layer to the glass core after disposing the first buffer layer on the first surface,
removing a polyethylene terephthalate film from the first buffer layer at the first surface after laminating the first buffer layer to the glass core at the first surface,
laminating the first buffer layer to the glass core after disposing the first buffer layer on the second surface, and
removing a polyethylene terephthalate film from the first buffer layer at the second surface after laminating the first buffer layer to the glass core at the second surface.

13. The method of claim 12, wherein disposing the composite build-up layer comprises:
disposing the composite build-up layer parallel to a length of the glass core and along (i) four corners of the glass core or (ii) a perimeter of the glass core, after removing the polyethylene terephthalate film from the first surface and the second surface.

14. The method of claim 13, further comprising:
(i) disposing a second buffer layer on the first buffer layer and on the composite build-up layer, and laminating the second buffer layer to the first buffer layer and the composite build-up layer to render the composite build-up layer incorporated in the first buffer layer;
or
(ii) disposing a polyethylene terephthalate film on the first buffer layer and on the composite build-up layer, and laminating the polyethylene terephthalate film to the first buffer layer and the composite build-up layer to render the composite build-up layer incorporated in the first buffer layer.

15. The method of claim 14, further comprising:
removing a polyethylene terephthalate film from the second buffer layer in (i) after laminating the second buffer layer to the first buffer layer and the composite build-up layer;
or
removing the polyethylene terephthalate film in (ii) after laminating the polyethylene terephthalate film to the first buffer layer and the composite build-up layer.

16. The method of claim 14,
wherein second buffer layer in (i) is disposed on the first surface and the second surface;
or
wherein the polyethylene terephthalate film in (ii) is disposed on the first surface and the second surface.

17. A system comprising:
a loading module;
an alignment module, wherein the loading module comprises an arm operable to convey a substrate carrier to the alignment module, and wherein the alignment module comprises an arm operable to align an electrically conductive frame and a glass core with each other on the substrate carrier;
a lamination module configured downstream of the alignment module operable to form a glass substrate from the glass core; and
an unloading module comprising an arm operable to convey the glass substrate out from the lamination module.

18. The system of claim 17, wherein the arm of the loading module is operable to have the substrate carrier placed in the alignment module to have the electrically conductive frame aligned with vertical edges of the glass core, and wherein the glass core is disposed within an opening of the electrically conductive frame.

19. The system of claim 17, wherein the lamination module comprises:
a heater;
a vacuum rubber press and/or a hydraulic vacuum press; and
a conveying unit comprising rollers to convey the glass core through the vacuum rubber press and/or the hydraulic vacuum press.

20. The system of claim 19, wherein the vacuum rubber press comprises rubber pads operable to apply pressure and heat so as to form the glass substrate, and/or wherein the hydraulic vacuum press comprises a hydraulic press operable to apply pressure under vacuum so as to form the glass substrate.
